(19) United States
(12) Patent Application Publication
(10) Pub. No.: US 2012/0217862 A1
(43) Pub. Date: Aug. 30, 2012

(54) LIGHT BULB SHAPED LAMP AND LIGHTING APPARATUS

(75) Inventors: Tsugihiro Matsuda, Kyoto (JP); Nobuyoshi Takeuchi, Osaka (JP); Hideo Nagai, Osaka (JP); Masahiro Miki, Osaka (JP); Takaari Uemoto, Osaka (JP)

(73) Assignee: PANASONIC CORPORATION, Osaka (JP)

(21) Appl. No.: 13/393,552

(22) PCT Filed: Sep. 22, 2011
(86) PCT No.: PCT/JP2011/005331

§ 371 Date: Mar. 1, 2012

(30) Foreign Application Priority Data
Dec. 24, 2010 (JP) 2010-288609

(51) Int. Cl. H05B 33/08

(52) U.S. Cl. 313/46; 313/512

(57) ABSTRACT

A light bulb shaped lamp capable of achieving light-distribution property equivalent to that of a conventional incandescent light bulb and easily fixing the LED module in the lamp is provided. The lamp according to the present invention includes an LED module housed in a hollow globe and a fixing component for fixing the LED module. The LED module includes a translucent board having a first main surface with an LED mounted thereon and a second main surface. The board includes a first light-emitting area and a second light-emitting area, the first light-emitting area in which predetermined light by the LED is emitted from the first main surface toward the globe, and the second light-emitting area in which predetermined light by the LED is emitted from the second main surface toward the globe.

### TECHNICAL FIELD

The present invention relates to a light bulb shaped lamp including a semiconductor light-emitting device and a lighting apparatus including the light bulb shaped lamp.

### BACKGROUND ART

Compared to conventional illumination light source, light emitting diodes (LED) which is a semiconductor light-emitting element is small, has high efficiency and long lifetime. Recent market needs for saving energy and resource boost the demand for light bulb shaped lamp using LED (hereafter simply referred to as “LED light bulb”), replacing the conventional incandescent light bulb using filament coil.

Known properties of LEDs include reduced light output and shorter lifetime as the temperature increases. In response to this problem, a metal case is provided between semisphericai globe and a base in a conventional LED light bulb so as to suppress the increase in the temperature of LED (for example, see Patent Literature 1).

The following shall describe a conventional LED lamp 400 disclosed in the patent literature 1 with reference to FIG. 17. FIG. 17 is a cross-sectional view of the light bulb shaped LED lamp according to the conventional technology.

As illustrated in FIG. 17, the conventional LED lamp 400 includes a translucent cover 410 which is a semispherical globe, a base 420 for receiving power, and an outer case 430 which is a metal case.

The outer case 430 includes a peripheral portion 431 exposed to outside, a circular-plate light-source attachment 432 integrally formed with the circumferential part 431, and a recess 433 formed inside of the circumferential portion 431. On the upper surface of the light-source attachment 432, an LED module 440 which includes LEDs is attached. Note that, an insulator 450 formed along the shape of the inner surface of the recess 433 is provided on the inner surface of the recess 433, and a lighting circuit 460 for lighting the LEDs are housed in the insulator 450.

With the conventional light bulb shaped LED lamp 400 having the configuration described above, the outer case 430 in which the light-source attachment 432 and the peripheral portion 431 are integrally formed is used. Thus, the heat generated at the LED is effectively conducted from the light-source attachment 432 to the peripheral portion 431. With this, the increase in the temperature of the LED is suppressed, thereby preventing reduction of the light output from the LEDs.

### CITATION LIST

### Patent Literature

[Patent Literature 1] Japanese Unexamined Patent Application Publication No. 2006-313717

### SUMMARY OF INVENTION

### Technical Problem

However, in the conventional light bulb shaped LED lamp 400 in Patent Literature 1, the LED module 440 is provided on the light-source attachment 432 in the outer case (metal case) 430. Consequently, the light toward the base 420 is blocked by the outer case 430, and the light is distributed differently from incandescent light bulbs. In other words, with the conventional LED light bulbs, it is difficult to achieve the light-distribution property equivalent to incandescent light bulbs, that is, the omnidirectional light-distribution property.

Thus, changing the configuration of the LED light bulbs to the same configuration of the incandescent light bulbs is one possible option. More specifically, a configuration of such an LED light bulb includes an LED module replacing a filament coil installed between the two lead wires of an incandescent light bulb.

However, the LED module used for the conventional light bulb shaped LED lamp emits light only from one side of the board on which the LED is mounted. As a result, there is a problem that simply replacing the filament coil with the LED module as described above would not yield the light distribution property equivalent to that of incandescent light bulbs.

In addition, the LED module is heavier than the filament coil used in incandescent light bulbs. Accordingly, there is another problem that merely supporting the LED module with the two lead wires in the same manner as the filament coil would not keep the LED module remaining at a constant position in the globe.

The present invention has been conceived in order to solve the problems, and it is an object of the present invention to provide a light bulb shaped lamp capable of achieving light-distribution property equivalent to that of a conventional incandescent light bulb and easily fixing the LED module in the lamp, and a lighting apparatus including the light bulb shaped lamp.

### Solution to Problem

In order to achieve the above-mentioned object, the light bulb shaped lamp according to an aspect of the present invention is an light bulb shaped lamp including: a globe which is hollow; a light-emitting module housed in the globe; and a fixing component for fixing the light-emitting module, in which the light-emitting module includes: a translucent board having a first main surface and a second main surface opposite to the first main surface; and a semiconductor light-emitting device mounted on the first main surface of the board, the board includes a first light-emitting area and a second light-emitting area, the first light-emitting area being an area in which predetermined light by the semiconductor light-emitting device is emitted from the first main surface toward the globe, and the second light-emitting area being an area in which predetermined light by the semiconductor light-emitting device is emitted from the second main surface toward the globe, and the board is provided standing on the fixing component.

With this configuration, it is possible to emit the predetermined light from both sides of the board toward the side circumferential portion of the globe. Thus, it is possible to achieve the omnidirectional light-distribution property easily. In addition, the light-emitting module can be easily fixed in the lamp by the fixing component.

Furthermore, in the light bulb shaped lamp according to an aspect of the present invention, it is preferable that the globe has an opening plane, and the first main surface of the board is substantially orthogonal to the opening plane.

With this configuration, it is possible to emit the predetermined light in a direction substantially horizontal to an opening plane of the globe. Thus, it is possible to evenly emit light toward the side circumferential portion of the globe.

Furthermore, in the light bulb shaped lamp according to an aspect of the present invention, it is preferable that an edge portion of the board is fixed to the fixing component.

With this configuration, it is possible to fix the light-emitting module with the fixing component using the edge portion of the board.

Furthermore, in the light bulb shaped lamp according to an aspect of the present invention, it is preferable that the light-emitting module further includes: a first power supply terminal and a second power supply terminal for supplying voltage from an external power source to the semiconductor light-emitting device, the first power supply terminal is formed on an end portion of the board on a side of the fixing component, and the second power supply terminal is formed on an end portion of the board on a side opposite to the side of the fixing component.

With this configuration, it is possible to secure the insulation distance between the first power supply terminal and the second power supply terminal as much as possible. Thus, it is possible to prevent the discharge between the first power supply terminal and the second power supply terminal from occurring.

Furthermore, the light bulb shaped lamp according to an aspect of the present invention, preferably includes at least two light-emitting modules each of which is the light-emitting module, in which the two light-emitting modules are fixed to the fixing component such that the first main surface of one of the two light-emitting modules is in a direction opposite to the first main surface of the other of the two light-emitting modules.

With this configuration, the two same light-emitting modules are arranged with the main surfaces of the boards reversed from each other. Thus, it is possible to emit light with the same light-distribution property toward the side circumferential portion of the globe.

Furthermore, in the light bulb shaped lamp according to an aspect of the present invention, the light-emitting module further preferably includes a first power supply terminal and a second power supply terminal for supplying voltage to the semiconductor light-emitting device, and the first power supply terminal and the second power supply terminal are formed on an end portion of the board on a side of the fixing component.

With this configuration, it is possible to shorten the power supply wire (lead wire) for supplying power to the light-emitting module. Thus, it is possible to prevent the light emitted from the light-emitting module from blocked by the power supply wire.

Furthermore, in the light bulb shaped lamp according to an aspect of the present invention, the first power supply terminal is preferably formed on the first main surface of the board, and the second power supply terminal is preferably formed on the second main surface of the board.

With this configuration, even when the first power supply terminal and the second power supply terminal are provided only on one side of the board, it is possible to secure the insulation distance between the first power supply terminal and the second power supply terminal. Thus, it is possible to prevent the discharge between the first power supply terminal and the second power supply terminal from occurring.

Furthermore, in the light bulb shaped lamp according to an aspect of the present invention, the fixing component preferably has a groove, and the edge portion of the board is inserted into the groove.

With this configuration, it is possible to regulate the position and the orientation of the board by the groove, and the light-emitting module can be arranged and fixed in the globe easily and stably.

Furthermore, in the light bulb shaped lamp according to an aspect of the present invention, the fixing component preferably includes an electric contact for supplying power to the first power supply terminal and the second power supply terminal, and the contact is formed on the groove.

With this configuration, it is possible to fix the light-emitting module and electrically connect the light-emitting module at the same time. This facilitates assembly.

Furthermore, in the light bulb shaped lamp according to an aspect of the present invention, the board preferably includes, on a side of the fixing component, a wide part at which a width is greater than other parts, and the first power supply terminal and the second power supply terminal are formed on the wide-width part.

With this configuration, the insulation distance between the first power supply terminal and the second power supply terminal is secured. Thus, it is possible to prevent the discharge between the first power supply terminal and the second power supply terminal from occurring.

Furthermore, in the light bulb shaped lamp according to an aspect of the present invention, the board preferably has a slit formed between the first power supply terminal and the second power supply terminal.

With this configuration, the insulation distance between the first power supply terminal and the second power supply terminal is secured as well. Thus, it is possible to prevent the discharge between the first power supply terminal and the second power supply terminal from occurring.

Furthermore, in the light bulb shaped lamp according to an aspect of the present invention, the fixing component preferably includes a plug-in part to be inserted into the slit.

With this configuration, it is possible to stably fix the board with the fixing component even if the board has an elongated shape.

Furthermore, in the light bulb shaped lamp according to an aspect of the present invention, the fixing component preferably has an electric contact for supplying power to the first power supply terminal and the second power supply terminal, and the electric contact is formed at the plug-in part.

With this configuration, it is possible to fix the light-emitting module and electrically connect the light-emitting module at the same time. This facilitates assembly.

Furthermore, in the light bulb shaped lamp according to an aspect of the present invention, the light-emitting module preferably further includes: a first wavelength conversion part which is formed on the first main surface of the board and performs wavelength conversion on light emitted by the semiconductor light-emitting device into the predetermined light; and a second wavelength conversion part which is formed on the second main surface of the board and performs wavelength conversion on light emitted by the semiconductor light-emitting device into the predetermined light.

With this configuration, the light converted into the predetermined light by wavelength conversion is emitted from both surfaces of the light-emitting module.

Furthermore, in the light bulb shaped lamp according to an aspect of the present invention, the fixing component is preferably composed of a material having a thermal conductivity higher than a thermal conductivity of the board.

With this configuration, the heat generated at the light-emitting module can be effectively conducted to the fixing component. Thus, it is possible to effectively dissipate the heat from the light-emitting module.

Furthermore, in the light bulb shaped lamp according to an aspect of the present invention, a transmission factor of the board is preferably 80% or higher.

With this configuration, the light emitted from the semiconductor light-emitting device can easily transmit the board. Thus, the light from the semiconductor light-emitting device easily reaches the second main surface side.

Furthermore, the light bulb shaped lamp according to an aspect of the present invention preferably includes: a base for receiving power causing the semiconductor light-emitting device to emit light; and a case for insulating at least the fixing component and the base, and housing a lighting circuit for turning on the semiconductor light-emitting device.

With this configuration, the fixing component and the base are insulated by the insulation case.

Furthermore, the lighting apparatus according to an aspect of the present invention the light bulb shaped lamp according to an aspect of the present invention.

As described above, the present invention can also be implemented as the lighting apparatus including the light bulb shaped lamp.

### Advantageous Effects of Invention

According to the present invention, the light-distribution property identical to the conventional incandescent light bulb can be achieved, and the LED module can be easily fixed in the lamp.

### BRIEF DESCRIPTION OF DRAWINGS

FIG. 1 is a diagrammatic perspective view of the light bulb shaped lamp according to the embodiment 1 of the present invention.

FIG. 2 is an exploded perspective view of the light bulb shaped lamp according to the embodiment 1 of the present invention.

FIG. 3 is a cross-sectional view of the light bulb shaped lamp according to the embodiment 1 of the present invention.

FIG. 4 is a diagram illustrating an LED module in the light bulb shaped lamp according to the embodiment 1 of the present invention.

FIG. 5 is a cross-sectional view of the light bulb shaped lamp according to the embodiment 2 of the present invention.

FIG. 6 is an enlarged perspective view of a major part of the light bulb shaped lamp according to the embodiment 3 of the present invention.

FIG. 7 is an enlarged plan view of a major part of the light bulb shaped lamp according to the embodiment 4 of the present invention.

FIG. 8 is an enlarged plan view of a major part of the light bulb shaped lamp according to the embodiment 5 of the present invention.

FIG. 9 is an enlarged plan view of a major part of the light bulb shaped lamp according to the embodiment 6 of the present invention.

FIG. 10 is an enlarged plan view of a major part of the light bulb shaped lamp according to the embodiment 7 of the present invention.

FIG. 11 is an enlarged view of a major part of the light bulb shaped lamp according to the embodiment 8 of the present invention.

FIG. 12 is an enlarged view of a major part of the light bulb shaped lamp according to the embodiment 9 of the present invention.

FIG. 13 is an enlarged plan view of a major part of the light bulb shaped lamp according to the embodiment 10 of the present invention.

FIG. 14 is an enlarged plan view of a major part of the light bulb shaped lamp according to the embodiment 11 of the present invention.

FIG. 15 is a schematic cross-sectional view of a lighting apparatus according to the embodiment of the present invention.

FIG. 16 is a schematic view of another lighting apparatus according to the embodiment of the present invention.

FIG. 17 is a cross-sectional view of the light bulb shaped LED lamp according to the conventional technology.

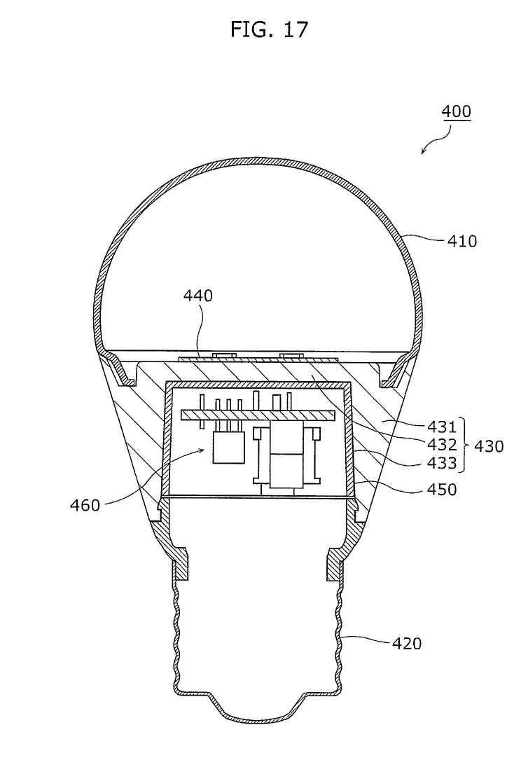

### DESCRIPTION OF EMBODIMENTS

The following shall describe a light bulb shaped lamp and a lighting apparatus according to the embodiments of the present invention with reference to the drawings. Note that, the diagrams are schematic diagrams, and illustration is not necessarily strictly accurate.

### Embodiment 1

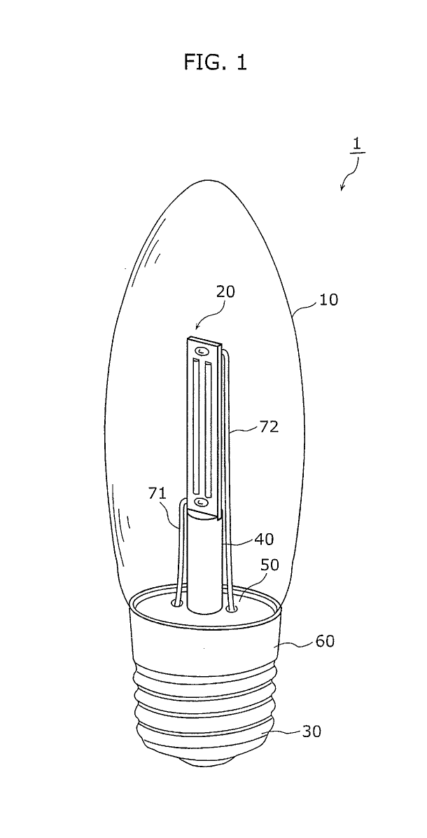

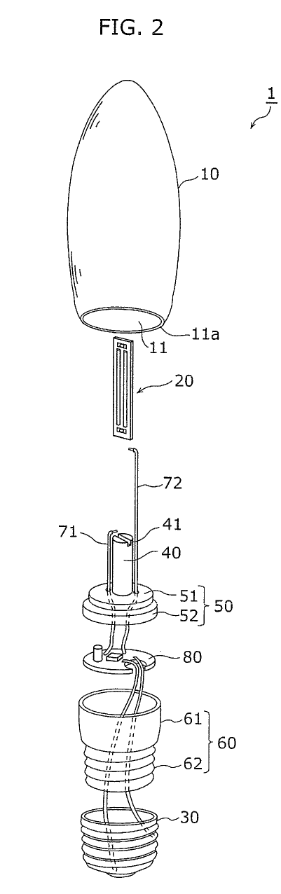

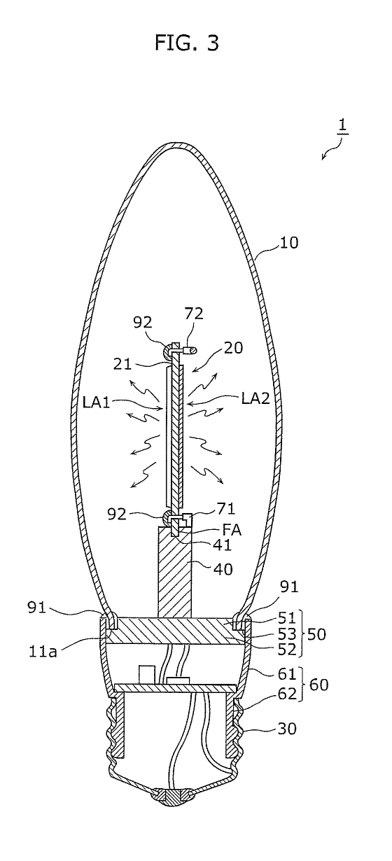

First, the overall structure of the light bulb shaped lamp according to the embodiment 1 of the present invention shall be described with reference to FIGS. 1 to 3. FIG. 1 is a diagrammatic perspective view of a light bulb shaped lamp according to the embodiment 1 of the present invention. FIG. 2 is an exploded perspective view of a light bulb shaped lamp according to the embodiment 1 of the present invention. FIG. 3 is a cross-sectional view of a light bulb shaped lamp according to the embodiment 1 of the present invention.

As illustrated in FIGS. 1 to 3, the light bulb shaped lamp 1 according to the embodiment 1 is an light bulb shaped LED lamp replacing incandescent lamp, and includes a translucent glob 10, an LED module 20, a base 30 for receiving power, and a fixing component 40 for fixing the LED module 20. The light bulb shaped lamp 1 according to the embodiment 1 also includes a supporting component 50, a resin case 60, a first lead wire 71, a second lead wire 72, and a lighting circuit 80. In this embodiment, an envelope of the light bulb shaped lamp 1 is the globe 10, the resin case 60, and the base 30.

The following shall describe components of the light bulb shaped lamp 1 according to the embodiment 1 with reference to FIGS. 1 to 3.

First, the globe 10 shall be described. As illustrated in FIGS. 1 to 3, the globe 10 is a hollow component for housing the LED module 20, and is a translucent component transmitting predetermined light from the LED module 20 to outside of the lamp.

In the embodiment 1, the globe 10 is configured of transparent glass (clear glass) made of silica glass. The LED module 20 housed in the globe 10 is visible from outside of the globe 10. As described above, having the transparent globe 10, it is possible to suppress loss of light from the LED module 20 due to the globe 10. Using glass for the globe 10 makes the globe 10 highly resistant to heat. Note that, the globe 10 may not only be made of silica glass, but also made of resin such as acrylic. The globe 10 may not be transparent, and diffusion treatment such as forming a diffusion film on an inner surface of the globe 10 may be performed.

The globe 10 has an opening 11 forming a substantially circular opening plane, and the overall shape of the globe 10 is a narrowly protruded prolate spheroid elongated from the opening 11. Note that, the shape of the globe 10 is not limited to the shape illustrated in FIG. 1. Type A (JIS C7710) used for the conventional incandescent light bulbs may be used. Alternatively, Type G or Type E may be also used. The globe 10 may be translucent to visible light, and may not necessarily be transparent.

Next, the LED module 20 shall be described. The LED module 20 is a light-emitting module (light-emitting device) which emits predetermined light, and is housed in the globe 10. The LED module 20 is supported and fixed by the fixing component 40. Preferably, the light-emitting portion of the LED module 20 is arranged at the central part of the globe 10 (for example, inside the large-diameter portion in which the inner diameter of the globe 10 is large). With this arrangement, the light bulb shaped lamp 1 can achieve the light distribution property approximated to a common incandescent light bulb using a conventional filament coil when switched on. Note that, the LED module 20 emits light by electric power supplied from the two lead wires, namely, the first lead wire 71 and the second lead wire 72. Although coated wires that are widely used are used for the lead wires, other conductive wires such as Ni—Fe wires may be used.

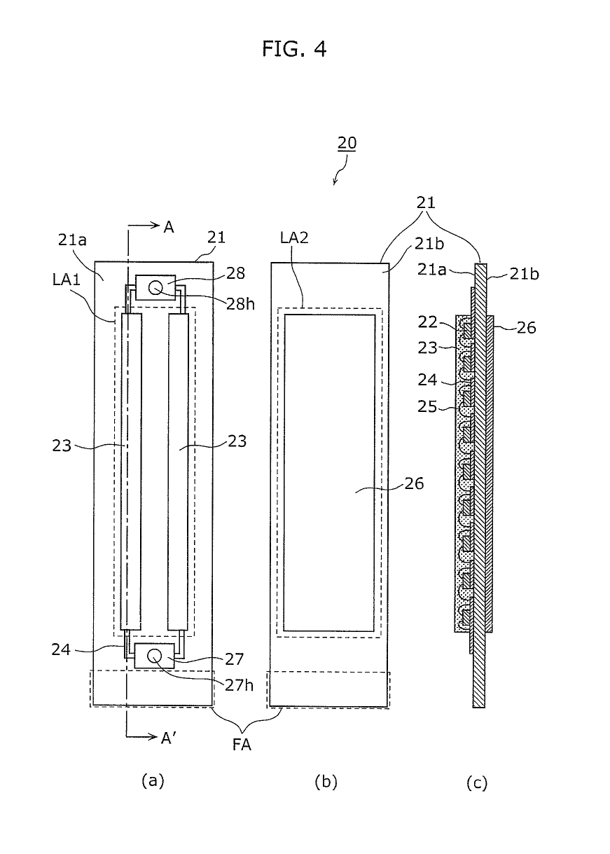

Each of the components of the LED module 20 according to the embodiment 1 shall be described in further detail with reference to FIG. 4. FIG. 4 is a diagram illustrating the configuration of the LED module in the light bulb shaped lamp according to the embodiment 1 of the present invention, and (a) is a plan view of the LED module (a plan view on the first main surface side), (b) is a back view of the LED module (a plan view on the second main surface side), and (c) is a cross-sectional view of the LED module along the A-A′ cross section in (a).

As illustrated in (a) to (c) in FIG. 4, the LED module 20 according to the embodiment 1 includes a translucent board 21, LEDs 22 each of which is a light-emission source, a sealing component 23 for sealing the LEDs 22, lines 24, and wires 25. The LED module 20 further includes a sintered-material film 26 which serves as a wavelength conversion component, a first power supply terminal 27, and a second power supply terminal 28.

Note that, the LED module 20 according to the embodiment 1 is a chip-on-board (COB) LED module configured of LED chips (bare chips) directly mounted on the board 21.

First, the board 21 shall be described. The board 21 is a translucent board including a first main surface 21a on which the LEDs 22 are mounted and a second main surface 21b which is a surface on the other side of the first main surface 21a. The board 21 is an elongated tabular rectangle board, and is a translucent board which transmits light emitted by the LEDs 22.

In the embodiment 1, the LED module 20 is configured such that the light is emitted from both of the main surfaces of the board 21, and as illustrated in (a) in FIG. 4, the board 21 includes a first light-emitting area LA1 and a second light-emitting area LA2. The predetermined light from the LEDs 22 is emitted from the first main surface toward the globe 10 in the first light-emitting area LA1, and is emitted from the second main surface 21b toward the globe 10 in the light-emitting area LA2. The first light-emitting area LA1 and the second light-emitting area LA2 function as a light-emitting region in the LED module 20, and are areas with high emission power and luminous intensity. Note that, in the embodiment 1, the light wavelength-converted from the light emitted from the LEDs 22 is emitted from the first light-emission area LA1 and the second light-emission area LA2 as the predetermined light. The details shall be described later.

Furthermore, in the embodiment 1, the LEDs 22 are mounted only on one surface of the LED module 20. The light emitted from the LEDs 22 mounted on the first main surface 21a transmits the inside of the board 21 and is emitted from the second main surface 21b on which no

LED 22 is mounted. With this, the light is emitted from both of the main surfaces of the board 21.

Accordingly, the board 21 is preferably composed of a material having a transmittance of visible light equal to or higher than 80%. More preferably, the board 21 is composed of a material transparent to the light in the visible light range, that is, a material with a significantly high transmittance which allows seeing the other side through the board 21. With this, even when the LEDs 22 are mounted only on a surface of one side (the first main surface) of the board 21, the light is easily emitted from the other surface (the second main surface). Thus, it is possible to obtain omnidirectional light distribution property approximated to the light distribution property of incandescent light bulb.

As the board 21, a translucent ceramic board made of alumina or aluminum nitride, a transparent glass substrate, a substrate made of crystal, or a sapphire substrate may be used. In the embodiment 1, in consideration of heat radiation property, a translucent ceramic board (alumina substrate) made of alumina having a transmittance of 96% is used as the board 21. The board 21 is a rectangle board 22 mm long, 18 mm wide, and 1.0 mm thick in size.

As illustrated in (a) in FIG. 4, the board 21 includes a fixing area FA which is an area fixed with the fixing component 40. The fixing area FA1 is an area different from the first light-emitting area LA1 and the second light-emitting area LA2, and is an area which basically does not function as the light-emitting region of the LED module 20. More specifically, even if the light emitted from the LEDs 22 transmits the board 21 and is released from the fixing area FA, the emission power is low, and the fixing area FA is an area with low luminous intensity. In the embodiment 1, the fixing area FA is an edge portion on one end of the board 21 in the longer direction. The edge portion as the fixing area FA includes at least a side surface of the board 21 on the shorter side. In the embodiment 1, the edge portion also includes the first main surface 21a and the second main surface 21b. Note that, nothing other than a board protective layer and an insulator layer is basically formed in the edge portion. For example, the LEDs 22, the sealing component 23, the lines 24, the wires 25, the sintered-material film 26, the first power supply terminal 27, and the second power supply terminal 28 are not formed on the edge portion.

Next, the LED 22 shall be described. The LED 22 is an example of a semiconductor light-emitting device, and is directly mounted on the main surface 21a on the board 21. In the embodiment 1, the LED 22 is a bare chip which emits visible light in one color, and a plurality of the LEDs 22 are mounted on the board 21. Each of the LEDs 22 emits light omnidirectionally, that is, upward, downward, and laterally. 60% of the total light-emission is directed upward (in a direction from the first main surface toward the outside of the board), 20% of the total light-emission is directed laterally (in a direction horizontal to the board), and 20% of the total light-emission is directed downward (in a direction from the first main surface to the second main surface). Note that, the LEDs 22 are die-bonded on the board 21 by die-attaching material (die-bonding material).

In the embodiment 1, a blue LED chip which emits blue light when current flows is used for the LED 22. As a blue LED chip, a semiconductor light-emitting device made of gallium nitride having a central wavelength at 440 nm to 470 nm made of InGaN series material. Furthermore, in the embodiment 1, the LEDs 22 are formed only on one side of the board 21, that is, only on the first main surface 21a. Nine LEDs 22 are arranged as one row, and two rows of the LEDs 22 are arranged in straight lines. The LEDs 22 in the same row are electrically connected in series, and the rows are connected in parallel.

Note that, the number and arrangement of the LEDs 22 may be appropriately changed according to the use of the light bulb shaped lamp. For example, as replacement for miniature light bulb or mini light bulb, only one LED 22 may be mounted on the board 21. Alternatively, one row or multiple rows other than two rows of LEDs 22 may be mounted.

Next, the sealing component 23 shall be described. The sealing component 23 is formed on a first main surface 21a of the board 21, sealing the LEDs 22. In the embodiment 1, the sealing component 23 is formed such that one row of the LEDs 22 is sealed collectively, and two straight-line rows are formed, as illustrated in (a) in FIG. 4.

The sealing component 23 also includes first wavelength conversion material for converting the wavelength of light emitted from the LED 22. A phosphor-containing resin in which predetermined phosphor particles is included in the predetermined resin as the first wavelength conversion material may be used as the sealing material 23, and may include translucent resin material such as silicone resin with dispersed phosphor particles.

As described above, in the embodiment 1, the sealing component 23 is the first wavelength conversion part which converts the light emitted from the LEDs 22 to predetermined light which is the illuminating light of the lamp, and is a light-emitting portion (first light-emitting portion) on the first main surface side of the board 21 in the LED module 20. Note that, the light-emitting area LA1 described above includes an area in which the sealing component 23 is formed, and is an area with high luminous intensity, appearing to emit the predetermined light.

More specifically, as the sealing material 23, when the LED 22 is the blue LED and when the illuminating light of the lamp is white, a phosphor containing resin in which yellow phosphor particles of yttrium, aluminum, and garnet (YAG) series dispersed in silicone resin. With this, part of blue light emitted from the LED 22 is converted to yellow light by wavelength conversion of the yellow phosphor particles included in the sealing component 23. The blue light that is not absorbed by the yellow phosphor particles and the yellow light obtained by the wavelength conversion by the yellow phosphor particles are dispersed in the sealing component 23 and mixed. The mixed light is emitted from the sealing component 23 to outside as white light.

The sealing component 23 with the configuration described above is formed by the following two processes, for example. First, in the first process, an uncured paste including the wavelength conversion material (phosphor particles), which is the component for the sealing component 23 is applied in straight line on the first main surface 21a on the board 21 by a dispenser, covering the LEDs 22. Next, in the second process, the applied paste of sealing material 23 is cured. With this, the sealing component 23 is formed. The cross-section of the sealing component 23 formed as described above is dome-shaped, and is 1 mm wide and 0.2 mm high.

Note that, in the embodiment 1, YAG series yellow phosphor particles are used as the wavelength conversion material contained in the sealing component 23. However, it is not limited to this example. For example, the first wavelength conversion material may be other yellow phosphor particles, or green phosphor particles and the red phosphor particles are used instead of the yellow phosphor particles.

In addition, the main component of the sealing component 23 may not necessarily be a silicone resin, and may be made of an organic material such as fluorine series resin or an inorganic material such as a low-melting-point glass or a sol-gel glass. Since the inorganic materials are more highly resistant to heat than the organic material, the sealing component 23 made of inorganic material is advantageous to a lamp with high luminance.

Furthermore, the sealing component 23 may contain light-diffusion material as necessary. Particles such as silica are used as the light diffusion material.

In the embodiment 1, the sealing component 23 is formed for each row of the LEDs 22. However, the sealing component 23 may be formed to collectively seal all of the mounted LEDs 22.

Next, the line 24 shall be described. The lines 24 are made of conductive material, and are patterned in a predetermined shape on the first main surface 21a on the board 21 in order to electrically connect LEDs 22. In the embodiment 1, the lines 24 are patterned such that nine LEDs 22 in the same row are connected in series, and the rows of the LEDs 22 are connected in parallel.

The lines 24 are also formed for electrically connecting the first power supply terminal 27 and an LED 22 on one of the ends, and for electrically connecting the second power supply terminal 28 and the LED 22 on the other end.

Metal lines such as silver (Ag), tungsten (W), copper (Cu) or others are used for the lines 24, and the surfaces of the lines 24 are plated with nickel (Ni)/gold (Au) or others. The lines 24, may also be formed of translucent conductive component such as indium tin oxide (ITO).

Next, the wire 25 shall be described. The wire 25 is for electrically connecting the LEDs 22 and the lines 24, and are made of gold wire, for example. A positive electrode and a negative electrode for supplying current are formed on the upper surface of the chip of the LED 22, and the positive electrodes, the negative electrodes, and the lines 24 are wire-bonded by the wire 25. Note that, in the embodiment 1, the wire 25 is buried in the sealing component 23.

Next, the sintered-material film 26 shall be described. As illustrated in (b) and (c) in FIG. 4, the sintered-material film 26 is a thin-film sintered material formed on the second main surface 21b on the board 21, and includes a second wavelength conversion material for converting the wavelength of light from the LED 22 transmitted the board 21, and a binder for sintering made of inorganic material.

The second wavelength conversion material of the sintered-material film 26 converts the wavelength of light transmitted the board 21, among the light emitted from the LEDs 22 mounted on the first main surface 21a on the board 21, and emits the wavelength-converted light. Phosphor particles which are excited by the light emitted from the LED 22 and emit predetermined light may be used as the second wavelength conversion material. For example, when white light is obtained as the illuminating light from the lamp using the LED 22 which is a blue LED emitting blue light, YAG-series yellow phosphor particles are used, in the same manner as the first wavelength conversion material in the sealing component 23.

The binder for sintering the sintered material film 26 is made of inorganic material, and transmits the light emitted from the LED 22 and the wavelength-converted light from the LED 22 with wavelength converted by the second wavelength conversion material. As the binder for sintering, glass frit (frit glass) made of silicon oxide (SiO₂) as the major component may be used. The glass frit is a binder (bonding material) for binding the second wavelength conversion material (phosphor particles) and the board 21, and is made of material having a high transmittance. The glass frit may be formed by heating glass powder in order to fuse the glass powder. As the glass powder for the glass frit, SiO₂—B₂O₃—R₂O series, B₂O₃—R₂O series or P₂O₅—R₂O series (However, all of the R₂O is Li₂O, Na₂O, or K₂O) may be used. Alternatively, as the material for binder for sintering, SnO₂—B₂O₃ made of low-melting point crystals may also be used other than the glass frit.

The sintered material film 26 with the configuration described above may be formed using a paste of the second wavelength conversion material, the binder for sintering, solvent, and others obtained by mixing and kneading. The paste is printed or applied on the second main surface 21b of the board 21, and sintered so as to form the sintered material film 26. Note that, the sintered material film 26 is formed before mounting the LEDs 22 on the first main surface 21a.

As described above, in the embodiment 1, the sintered material film 26 is the second wavelength conversion part which converts the wavelength of the light emitted from the LEDs 22 to predetermined light for the illuminating light of the lamp, and is a light-emitting portion (second light-emitting portion) on the second main surface side of the board 21 in the LED module 20. Note that, the second light-emitting area LA2 described above is an area in which the sintered material film 26 is formed, and is an area with high luminous intensity, appearing to emit the predetermined light. In the embodiment 1, the second light-emitting area LA2 has the same area as the first light-emitting area LA1.

In the embodiment 1, the sintered material film 26 is formed in rectangular shape having a thickness of 50 μm. It is preferable that the thickness of the sintered material film is from 10 μm to 500 μm.

Note that, in the embodiment 1, the sintered material is used as the second wavelength conversion part. However, the second wavelength conversion part may be composed of the phosphor containing resin identical to the first wavelength conversion part. However, the configuration in which the second wavelength conversion part is composed of the sintered material made of inorganic material (the sintered material film 26) not only prevents the degradation caused by the heat from the LED 22, but also allows effective dissipation of heat from the LED 22, compared to the case in which the second wavelength conversion part is made of resin. With this, it is possible to implement the highly reliable LED module 20 having high heat-dissipation property.

Next, the first power supply terminal 27 and the second power supply terminal 28 shall be described. The first power supply terminal 27 and the second power supply terminal 28 are connecting terminals for connecting the LED module 20 to an external power source outside of the LED module 20 in order to receive a DC voltage for lighting the LEDs 22, and are power supply terminals for supplying the DC voltage received from the external power source to the LEDs 22. In the embodiment 1, the DC voltage is supplied to the first power supply terminal 27 and the second power supply terminal 28 from the lighting circuit 80 in the lamp as the external power source, and thus the DC voltage is supplied to each of the LEDs 22 through the lines 24 and the wire 25. With the supply of the DC voltage, the LEDs 22 emit light (light up).

As illustrated in (a) in FIG. 4, in the embodiment 1, both the first power supply terminal 27 and the second power supply terminal 28 are provided on the first main surface 21a of the board 21. The first power supply terminal 27 and the second power supply terminal 28 are formed opposite to each other on one end portion and the other end portion of the board 21 in the longer direction. Note that, the first power supply terminal 27 is formed on an end portion of the board 21 on the fixing component 40 side, and the second power supply terminal 28 is formed on the other end portion of the board 21 opposite to the fixing component 40 side. As described above, it is possible to secure the distance between the first power supply terminal 27 and the second power supply terminal 28 for insulating by providing the first power supply terminal 27 and the second power supply terminal 28 on both end portions of the board 21. Thus, it is possible to prevent electric discharge and others between the first power supply terminal 27 and the second power supply terminal 28.

In the first power supply terminal 27 and the second power supply terminal 28, through holes 27h and 28h penetrating the board 21 are provided, respectively. The through holes 27h and 28h are portions for inserting the connecting portions at the end of the first lead wire 71 and the second lead wire 72, respectively. As illustrated in FIG. 3, the through-holes 27h and 28h are connecting portions for electrically and physically connecting the first power supply terminal 27 and the first lead wire 71 by the solder 92 and connecting the second power supply terminal 28 and the second lead wire 72 by the solder 92, respectively.

In the LED module 20 according to the embodiment with the configuration described above, the emitted light is set to be white light, and in the first light-emitting part on the first main surface 21a side on the board 21, yellow light is emitted by the yellow phosphor particles (the first wavelength conversion material) in the sealing component 23 excited by the blue light from the blue LED chip, and the white light is emitted from the first light-emitting area LA1 by the excited yellow light and the blue light emitted from the blue LED chip.

In contrast, in the second light-emitting region on the second main surface 21b on the board 21, yellow light is emitted from the yellow phosphor particles in the sintered material film 26 (second wavelength conversion material) excited by the blue light from the blue LED chip transmitted the board 21. Accordingly, white light is emitted from the second light-emitting area LA2 as well.

The LED module 20 according to the embodiment 1 is provided such that the board 21 stands on the fixing component 40 and fixed to the fixing component 40. In other words, the board 21 is fixed standing, and the board 21 is placed such that at least the first main surface 21a is orthogonal to the plane of the opening 11 of the globe 10.

In the embodiment 1, the board 21 is fixed to the fixing component 40 such that the board 21 is vertically arranged, as illustrated in FIGS. 1 and 3. The first main surface 21a of the board 21 is provided substantially orthogonal to a plane including the plane of the opening 11 of the globe 10. More specifically, the LED module 20 is arranged such that the first main surface 21a of the board 21 is substantially in parallel with the arrangement direction for the fixing component 40 and the board 21.

With this configuration, the predetermined light emitted form the LED module 20 is emitted toward the side circumferential direction of the globe 10. More specifically, the predetermined light emitted from the first light-emitting area LA1 and the second light-emitting area LA2 is radially emitted toward the side circumferential direction of the globe 10. With this, the omnidirectional light distribution property can be achieved with the LED module 20 as the light-source of the lamp. Note that, in the embodiment 1, the luminous fluxes of the light emitted from the first light-emitting area LA1 and the light emitted from the second light-emitting area LA2 are set to be in the same level.

Next, the base 30 shall be described. In the embodiment 1, the base 30 is a receiving part for receiving power for causing the LEDs 22 in the LED module 20 to emit light, and receives AC voltage from an AC power source (for example a commercial power source of AC 200V) with two contact points, as illustrated in FIGS. 1 to 3. The power received by the base 30 is input to the power input unit of the lighting circuit 80 through the lead wire.

The base 30 is the type E, for example, and a screw part for screwing in a socket of the lighting apparatus is formed on the outer circumferential surface of the base 30. In addition, on the inner circumferential surface of the base 30, a screw for screwing in the resin case 60 is formed. Note that, the base 30 is a metal tube with a bottom.

In the embodiment 1, the base 30 is a type E26 base. Accordingly, the light bulb shaped lamp 1 is attached to the socket for the E26 base connected to a commercial AC power source for use. Note that, the base 30 does not have to be a type E26 base, but also a type E17 base or others. The base 30 does not have to be a screw-in base, but may also be a base of different shape, for example, a plug-in base.

Next, the fixing component 40 shall be described. As illustrated in FIGS. 1 to 3, the fixing component 40 is a component for fixing the LED module 20 at a predetermined position in the globe 10, and extends from the proximity of the opening 11 of the globe 10 toward the inside of the globe 10. In the embodiment 1, the fixing component 40 is cylindrical, and one end of the fixing component 40 is connected to the LED module 20 and the other end of the fixing component 40 is connected to the supporting component 50.

A groove 41 is formed on a top surface on one end of the fixing component 40 (a surface on the LED module 20 side). The groove 41 is formed such that the width of the groove is approximately the same as the thickness of the board 21 in the LED module 20. For example, the shape of the groove 41 may be a recess in cross-section, fitting the edge portion of the board 21. With this, the edge portion of the board 21 (part of or all of the fixing area FA) on the shorter side of the board 21 is inserted into the groove 41. With this, the board 21 is placed on the fixing component 40. Note that, the fixing component 40 and the board 21 are bonded by adhesive or others applied around the groove 41.

As described above, in the embodiment 1, the LED module 20 is fixed to the fixing component 40 with the board 21 inserted into the groove 41 of the fixing component 40. With this, the position and direction of the board 21 (the position and direction of the LED module 20) can be regulated by the groove 41, and the LED module 20 is stably arranged and fixed in the globe 10.

Note that, in the embodiment 1, the groove 41 is formed in the fixing component 40, and the board 21 and the fixing component 40 are fixed. However, the groove 41 does not have to be formed. For example, the board 21 may be arranged vertically on a planar part of the upper surface of the fixing component 40 abutting the side surface of the board 21, and the board 21 and the fixing component 40 may be bonded. In the embodiment 1, the fixing component 40 and the board 21 are bonded by adhesive. However, it is not limited to this example. For example, the fixing component 40 and the board 21 may be fixed by screws or others.

In addition, the lower surface of the other end (a side opposite to the side fixed with the LED module 20) of the fixing component 40 abuts the surface of the supporting component 50, and the lower surface of the fixing component 40 and the supporting component 50 are fixed at the abutting portion. In the embodiment 1, the fixing component 40 and the supporting component 50 are fixed by screwing in screws from the back surface of the supporting component 50. Note that, the method of fixing the fixing component 40 and the supporting component 50 may not be limited to screws. The fixing component 40 and the supporting component 50 may be fixed by bonding using adhesive or others.

It is preferable for the fixing component 40 to be composed of a material having higher heat conductivity than the heat conductivity of the board 21 in the LED module 20. It is preferable that the fixing component 40 is composed of a material with a heat conductivity higher than the heat conductivity of glass (approximately 1.0[W/m•K], and may be composed of metal or inorganic material such as ceramic, for example. In the embodiment 1, the fixing component 40 is made of aluminium having a heat conductivity of 237[W/m•K].

As described above, having the heat conductivity of the fixing component 40 higher than the heat conductivity of the board 21 allows the heat from the LED module 20 to be effectively emitted to the fixing component 40 through the board 21. With this, the heat from the LED module 20 is dissipated toward the base 30. This suppresses the reduction in the light-emitting efficiency of the LED 22 and reduction in the lifetime due to increased temperature.

Next, the supporting component 50 shall be described. As illustrated in FIGS. 2 and 3, the supporting component 50 is a component connected to the opening end 11a of the opening 11 of the globe 10, and for supporting the fixing component 40. The supporting component 50 is configured to close the opening 11 of the globe 10. In the embodiment 1, the supporting component 50 is fixed, fitting into the resin case 60. Two insertion holes for inserting the first lead wire 71 and the second lead wire 72 are formed in the supporting component 50.

It is preferable for the supporting component 50 to be composed of a material having higher heat conductivity than the heat conductivity of the board 21 in the LED module 20. It is preferable that the supporting component 50 is formed with a material having heat conductivity higher than the heat conductivity of glass. For example, the supporting component 50 may be formed of metal material or inorganic material such as ceramic. In order to effectively conduct the heat at the fixing component 40 to the supporting component 50, it is preferable that the material for the supporting component 50 is composed of a material having a heat conductivity equal to or higher than the heat conductivity of the fixing component 40. In the embodiment 1, the supporting component 50 is composed of the same material as the fixing component 40; that is, aluminum having the heat conductivity of 237[W/m•K].

As described above, composing the supporting component 50 with a material with high heat conductivity allows the heat generated at the LED module 20 conducted to the fixing component 40 by heat conduction effectively conducted to the supporting component 50. Thus, it is possible to suppress the reduction in the luminous efficacy of the LED 22 and the reduction in lifetime due to the increase in temperature.

Furthermore, in the embodiment 1, the supporting component 50 is composed of a disc-shaped plate material, and includes a first supporting region 51 and the second supporting region 52. In the supporting component 50, the diameter of the second supporting region 52 is greater than the diameter of the first supporting region 51. Accordingly, a gap 53 is formed between the periphery of the first supporting region 51 and the periphery of the second supporting region 52. Note that, the first supporting region 51 and the second supporting region 52 are integrally formed.

As illustrated in FIG. 3, on the upper surface of the first supporting region 51 (on the surface toward the globe 10), the fixing component 40 is fixed. The inner surface of the resin case 60 abuts the side surface of the second supporting region 52. The opening end 11a of the opening 11 of the globe 10 abuts the gap 53. Accordingly, the opening 11 of the globe 10 is closed with the second supporting region 52. At the gap 53, the supporting component 50, the resin case 60, and the opening end 11a of the opening 11 of the globe 10 are bonded by an adhesive material 91. The adhesive material 91 fills the gap 53.

As described above, the supporting component 50 is connected to the globe 10. Thus, the heat from the LED module 20 conducted to the supporting component 50 is heat-conducted to the globe 10 composing the envelope, and is dissipated to air from the outer surface of the globe 10.

In addition, the supporting component 50 is connected to the resin case 60, and thus the heat from the LED module 20 conducted to the supporting component 50 is heat-conducted to the resin case 60, and is dissipated to air from the outer surface of the resin case 60 comprising the envelope as well.

Note that, the adhesive made of silicone resin may be used as the adhesive 91 for bonding the globe 10 and others. It is preferable that the adhesive material having high heat conductivity is used in order to effectively conduct heat from the LED module 20 from the supporting component 50 to the globe 10 and the resin case 60. For example, the heat conductivity can be increased by dispersing fine metal particles in the silicone resin, for example.

Next, the resin case 60 shall be described. As illustrated in FIGS. 2 and 3, the resin case 60 is an insulating case for insulating the fixing component 40 and the base 30 and for housing the lighting circuit 80. The resin case 60 is composed of a cylindrical first case part 61 and a cylindrical second case part 62.

The first case part 61 has an inner diameter substantially same as the outer diameter of the second supporting region 52 of the supporting component 50. The supporting component 50 is fitted and fixed into the first case part 61. The outer surface of the first case part 61 is exposed to outside. Thus, the heat conducted to the resin case 60 is mostly dissipated from the first case part 61.

The second case part 62 is composed such that the outer circumferential surface contacts the inner circumferential surface of the base 30, and in this embodiment, a screw part for screwing into the base 30 is formed on the outer circumferential surface of the second case part 62, and the second case part 62 contacts the base 30 through the screw part. Accordingly, the heat conducted to the resin case 60 is conducted to the base 30 through the second case part 62, and is dissipated from the outer surface of the base 30 as well.

In the embodiment 1, the first case part 61 and the second case part 62 of the resin case 60 are integrally formed, and may be formed by injection forming. The resin case 60 is made of polybutylene terephthalate (PBT) containing 5 to 15% of glass fiber and having a heat conductivity of 0.35[w/m•K].

Next, the first lead wire 71 and the second lead wire 72 shall be described. As illustrated in FIGS. 1 to 3, the first lead wire 71 and the second lead wire 72 are wires for supplying power for causing the LED module 20 to emit light to the LED module 20. The surfaces of the lead wires are coated with insulating resin film.

The first lead wire 71 and the second lead wire 72 are inserted through the supporting component 50. The ends on the one side of the first lead wire 71 and the second lead wire 72 are connected to the LED module 20, and the ends on the other side of the first lead wire 71 and the second lead wire 72 are electrically connected to the power output unit of the lighting circuit 80.

As illustrated in FIG. 3, the conductive end connecting part of one end of the first lead wire 71 is inserted into the through-hole 27h in the first power supply terminal 27 in the lower end part of the board 21. The first lead wire 71 and the first power supply terminal 27 are electrically connected by the solder 92.

In addition, the conductive end connecting part of one end of the second lead wire 72 is extended to the upper end portion of the board 21 and inserted into the through-hole 28h in the second power supply terminal 28 in the board 21. The second lead wire 72 and the second power supply terminal 28 are electrically connected by the solder 92.

Note that, it is preferable to arrange the second lead wire 72 extended up to the upper part of the board 21 adjacent to the side surface on the longer side of the board 21 and along the side surface in order not to block the light emitted from the LED module 20 as much as possible.

Next, the lighting circuit 80 shall be described. As illustrated in FIGS. 2 and 3, the lighting circuit 80 is a circuit for lighting the LEDs 22, and is housed in the resin case 60. The lighting circuit 80 includes a plurality of circuit elements and a circuit board for mounting the circuit elements.

In the embodiment 1, the lighting circuit 80 converts the AC power received from the base 30 into DC power, and supplies the DC power to the LEDs 22 through the first lead wire 71 and the second lead wire 72. The lighting circuit 80 may be composed of a diode bridge for full wave rectification, a capacitor for smoothing, and a resistor for adjusting current, for example.

Note that, it is not necessary for the light bulb shaped lamp 1 to incorporate the lighting circuit 80. For example, the light bulb shaped lamp 1 may not include the lighting circuit 80 when the DC power is directly supplied from the lighting apparatus or cells. In addition, the lighting circuit 80 is not limited to a smoothing circuit. A light-adjusting circuit, a voltage booster circuit, and others may be appropriately selected and combined.

According to the light bulb shaped lamp 1 according to the embodiment 1, the LED module 20 includes two light-emitting areas, namely, the first light-emitting region LA1 and the second light-emitting region LA2, and is configured to radiate predetermined light from both surfaces of the board 21 such that the light is omnidirectionally emitted. The LED module 20 is arranged in the globe 10 such that the board 21 stands on the fixing component 40. With this, it is possible to achieve the light-distribution property equivalent to conventional incandescent light bulbs, and the LED module 20 is easily fixed in the lamp.

In addition, the light emitted from the light-emitting areas in the LED module 20 travels omnidirectionally without blocked, since the board 21 is fixed with the fixing component 40 in the fixing area FA which is an area different from the light-emitting areas. This achieves omnidirectional light-distribution property.

### Embodiment 2

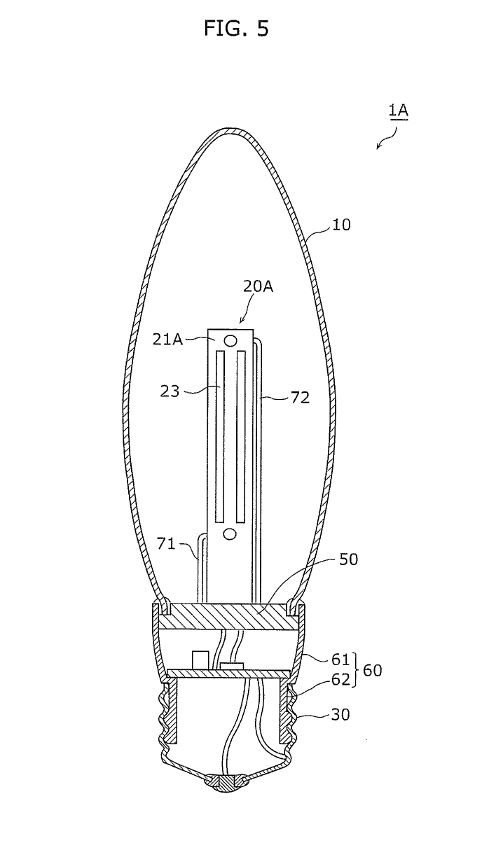

A light bulb shaped lamp 1A according to the embodiment 2 of the present invention shall be described with reference to FIG. 5. FIG. 5 is a cross-sectional view of a light bulb shaped lamp according to the embodiment 2 of the present invention.

The basic configuration of the light bulb shaped lamp 1A according to the embodiment 2 of the present invention is identical to the configuration of the light bulb shaped lamp 1 according to the embodiment 1 of the present invention. Accordingly, the same reference numerals are assigned to the components identical to the components illustrated in FIGS. 1 to 4, and the detailed description for these components is omitted.

The light bulb shaped lamp 1A according to the embodiment 2 of the present invention is different from the light bulb shaped lamp 1 according to the embodiment 1 of the present invention in the configuration of the LED module.

As illustrated in FIG. 5, in the light bulb shaped lamp 1A according to the embodiment 2, the fixing component 40 as in the embodiment 1 is not provided, and the board 21A in the LED module 20A is directly fixed with the supporting component 50.

More specifically, in the embodiment 2, the supporting component 50 serves as a fixing component for fixing the LED module 20A. In this case, the board 21A is provided standing on the supporting component 50, and the supporting component 50 and the board 21A are bonded with the side surface of the board 21A abutting the upper surface of the supporting component 50 (on a side of the globe 10). The supporting component 50 and the board 21A may be bonded with adhesive (not illustrated), for example.

Note that, in the same manner as the embodiment 1, a groove for fitting the edge portion of the board 21A on the shorter side is formed on the upper surface of the supporting component 50, and the edge portion (fixing area) of the board 21A on the shorter side is inserted into the groove. With this, the board 21A is fixed to the supporting component 50. The groove may be formed by forming a recess on a part of the upper surface of the supporting component 50.

Furthermore, when the light-distribution property equivalent to the embodiment 1 is achieved in the embodiment 2, a long board longer than the board 21 according to the embodiment 1 by the length of the fixing component 40 may be used as the board 21A according to the embodiment 2. On this board, the sealing component 23 which is the first light-emitting region and the sintered material film (not illustrated) which is the second light-emitting region may be provided, such that the positions of the first light-emitting area and the second light-emitting area with respect to the globe 10 are identical to the positions in the embodiment 1.

As described above, in the light bulb shaped lamp 1A according to the embodiment 2 of the present invention, the effects equivalent to the effects achieved by the light bulb shaped lamp 1 according to the embodiment 1 are achieved.

### Embodiment 3

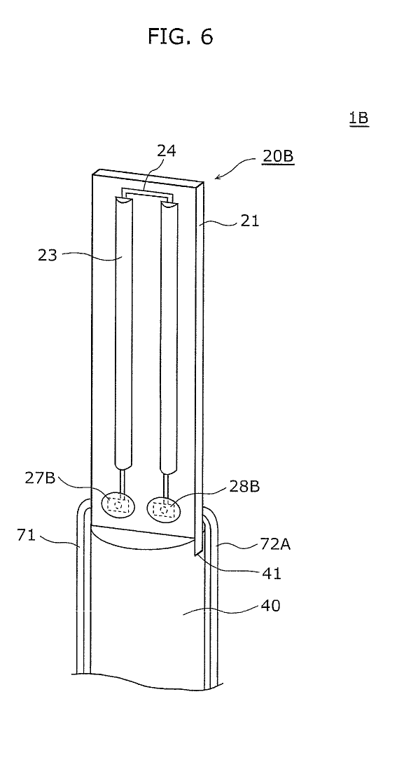

A light bulb shaped lamp 1B according to the embodiment 3 of the present invention shall be described with reference to FIG. 6. FIG. 6 is an enlarged diagrammatic perspective view of a major part of a light bulb shaped lamp according to the embodiment 3 of the present invention.

The overall basic configuration of the light bulb shaped lamp 1B according to the embodiment 3 of the present invention is identical to that of the light bulb shaped lamp 1 according to the embodiment 1 of the present invention. Thus, the description for the overall configuration of the lamp shall be omitted. In addition, the same reference numerals are assigned to the components identical to the components illustrated in FIGS. 1 to 4 in FIG. 6, and the detailed description for these components shall be omitted.

The light bulb shaped lamp 1B according to the embodiment 3 of the present invention is different from the light bulb shaped lamp 1 according to the embodiment 1 of the present invention in the arrangement of the power supply terminals in the LED module.

More specifically, in the LED module 20 according to the embodiment 1, the first power supply terminal 27 and the second power supply terminal 28 are provided away from each other on one side of the end portions and on the other side of the end portions of the board 21 in the longer direction, as illustrated in (a) in FIG. 4. However, in the LED module 20B in the light bulb shaped lamp 1B according to the embodiment 2, the first power supply terminal 27B and the second power supply terminal 28B are provided only on one side of the board 21, on the side of the fixing component 40, as illustrated in FIG. 6.

In addition, the line 24 is patterned on the upper part of the board 21 such that the LEDs in the two rows of the sealing component 23 are connected in series.

According to the light bulb shaped lamp 1B according to the embodiment 3 of the present invention, it is possible to achieve the effects equivalent to the effects of the embodiment 1.

Furthermore, since the first power supply terminal 27B and the second power supply terminal 28B in the light bulb shaped lamp 1B in the embodiment 3 are provided only on one side of the board 21 on the side of the fixing component 40, it is not necessary to extend the second lead wire 72A up to the upper end portion of the board 21, as the second lead wire 72 in the embodiment 1 illustrated in FIG. 1. With this, the light emitted from the LED module is not blocked by the extended lead wire. Thus, it is possible to implement a light bulb shaped lamp having a light-distribution property with a uniform, smooth light-distribution curve.

### Embodiment 4

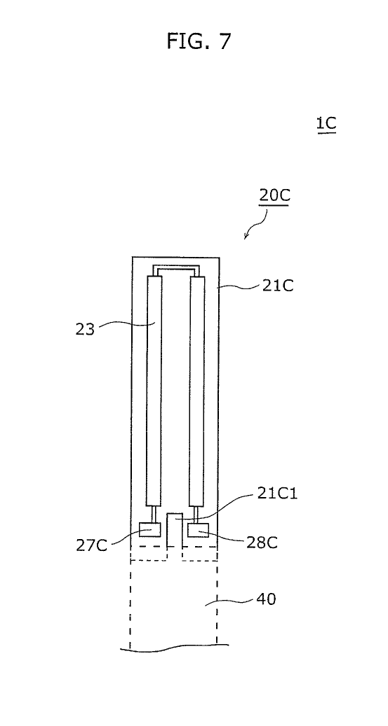

A light bulb shaped lamp 1C according to the embodiment 4 of the present invention shall be described with reference to FIG. 7. FIG. 7 is an enlarged plan view of the major part of the light bulb shaped lamp according to the embodiment 4 of the present invention.

Since the overall basic configuration of the light bulb shaped lamp 1C according to the embodiment 4 of the present invention is identical to that of the light bulb shaped lamp 1 according to the embodiment 1 of the present invention. Thus, the description for the overall configuration of the lamp shall be omitted. In addition, the same reference numerals are assigned to the components identical to the components illustrated in FIGS. 1 to 4 in FIG. 7, and the detailed description for these components shall be omitted.

The light bulb shaped lamp 1C according to the embodiment 4 of the present invention is different from the light bulb shaped lamp 1 according to the embodiment 1 of the present invention in the structure of the board in the LED module.

As illustrated in FIG. 7, the LED module 20C in the light bulb shaped lamp 1C according to the embodiment 4, in the same manner as the embodiment 3, the first power supply terminal 27C and the second power supply terminal 28C are provided only on one side of the board 21C on the side of the fixing component 40.

Furthermore, in the LED module 20C in the embodiment 4, a slit 21C1 is formed on the board 21C. The slit 21C1 is formed between the first power supply terminal 27C and the second power supply terminal 28C, and is cut out in a straight line from the shorter side of the board 21C on the side of the fixing component 40 toward the shorter side on the opposite side.

According to the light bulb shaped lamp 1C according to the embodiment 4 of the present invention, it is possible to achieve the effects equivalent to the effects of the embodiment 3.

Furthermore, in the light bulb shaped lamp 1C according to the embodiment 4, the slit 21C1 is formed between the first power supply terminal 27C and the second power supply terminal 28C. Thus, it is possible to increase the insulated distance between the first power supply terminal 27C and the second power supply terminal 28C, compared to the embodiment 3. With this, it is possible to prevent the discharge between the first power supply terminal 27C and the second power supply terminal 28C.

### Embodiment 5

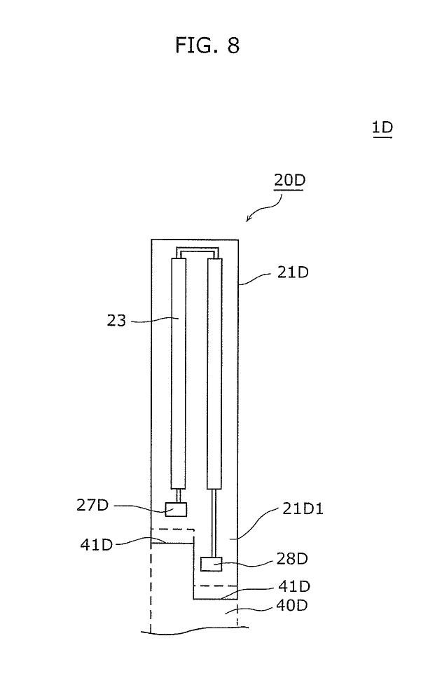

A light bulb shaped lamp 1D according to the embodiment 5 of the present invention shall be described with reference to FIG. 8. FIG. 8 is an enlarged plan view of the major part of the light bulb shaped lamp according to the embodiment 5 of the present invention. Note that, in FIG. 8, a fixing component 40D is illustrated in broken lines.

Since the overall basic configuration of the light bulb shaped lamp 1D according to the embodiment 5 of the present invention is identical to that of the light bulb shaped lamp 1 according to the embodiment 1 of the present invention. Thus, the description for the overall configuration of the lamp shall be omitted. In addition, the same reference numerals are assigned to the components identical to the components illustrated in FIGS. 1 to 4 in FIG. 8, and the detailed description for these components shall be omitted.

The light bulb shaped lamp 1D according to the embodiment 5 of the present invention is different from the light bulb shaped lamp 1 according to the embodiment 1 of the present invention in the structure of the board in the LED module and the shape of the fixing component.

As illustrated in FIG. 8, in the LED module 20D in the light bulb shaped lamp 1D according to the embodiment 5, the first power supply terminal 27D and the second power supply terminal 28D are formed only on one side of the board 21D, that is, on the side of the fixing component 40D.

Furthermore, in the LED module 20D, the board 21D has an extended portion 21D1 which is a part of the shorter side of the board 21D extended toward the fixing component 40D to have a gap on the side of the fixing component 40D. A second power supply terminal 28D is formed on the extended portion 21D1. A first power supply terminal 27D is formed in a region which is not extended.

Furthermore, the fixing component 40D is formed according to the shape of the fixing component 40D, and a gap is formed on the fixing component 40D on the side of the LED module 20D. On the upper surfaces of the fixing component 40D with a gap, the groove 41D fitting into the end portion of the board 21D, in the same manner as the embodiment 1.

According to the light bulb shaped lamp 1D according to the embodiment 5 of the present invention, it is possible to achieve the effects equivalent to the effects of the embodiment 3.

Furthermore, with the light bulb shaped lamp 1D according to the embodiment 5, it is possible to increase the insulation distance between the first power supply terminal 27D and the second power supply terminal 28D compared to the embodiment 3. Thus, it is possible to prevent the discharge between the first power supply terminal 27D and the second power supply terminal 28D.

### Embodiment 6

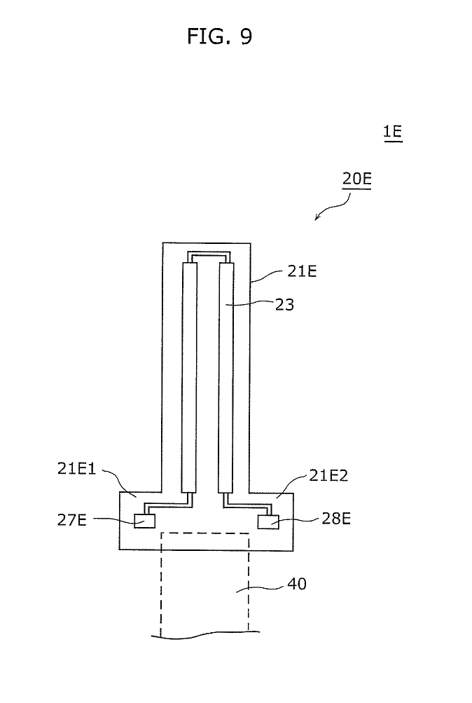

A light bulb shaped lamp 1E according to the embodiment 6 of the present invention shall be described with reference to FIG. 9. FIG. 9 is an enlarged plan view of the major part of the light bulb shaped lamp according to the embodiment 6 of the present invention. Note that, in FIG. 9, the fixing component 40 is illustrated in broken lines.

Since the overall basic configuration of the light bulb shaped lamp 1E according to the embodiment 6 of the present invention is identical to that of the light bulb shaped lamp 1 according to the embodiment 1 of the present invention. Thus, the description for the overall configuration of the lamp shall be omitted. In addition, the same reference numerals are assigned to the components identical to the components illustrated in FIGS. 1 to 4 in FIG. 9, and the detailed description for these components shall be omitted.

The light bulb shaped lamp 1E according to the embodiment 6 of the present invention is different from the light bulb shaped lamp 1 according to the embodiment 1 of the present invention in the structure of the board in the LED module.

As illustrated in FIG. 9, in an LED module 20E in the light bulb shaped lamp 1E according to the embodiment 6, a first power supply terminal 27E and a second power supply terminal 28E are formed only on one side of the board 21E, that is, on the side of the fixing component 40.

Furthermore, in the embodiment 6, the board 21E includes a first wide part 21E1 and a second wide part 21E2 on the side of the fixing component 40, in which the widths are wider than the other parts. The first power supply terminal 27E is formed on the first wide part 21E1, and the second power supply terminal 28E is formed on the second wide part 21E2.

According to the light bulb shaped lamp 1E according to the embodiment 6 of the present invention, it is possible to achieve the effects equivalent to the effects of the embodiment 3.

Furthermore, with the configuration described above, in the light bulb shaped lamp 1E according to the embodiment 6, the insulating distance between the first power supply terminal 27E and the second power supply terminal 28E can be longer than that of the embodiment 3. Thus, it is possible to prevent the discharge between the first power supply terminal 27E and the second power supply terminal 28E.

Note that, although the first wide part 21E1 and the second wide part 21E2 are formed in the embodiment 6, only one of them may be formed. More specifically, by forming only one of the first wide part 21E1 and second wide part 21E2 increases the insulating distance between the first power supply terminal 27E and the second power supply terminal 28E, preventing the discharge from occurring.

### Embodiment 7

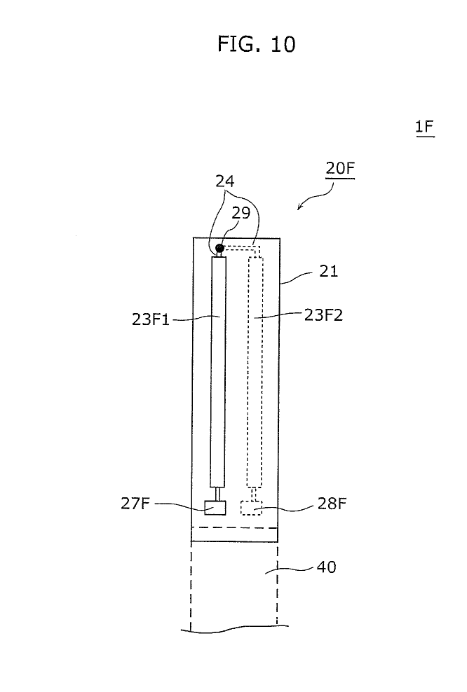

A light bulb shaped lamp 1F according to the embodiment 7 of the present invention shall be described with reference to FIG. 10. FIG. 10 is an enlarged plan view of the major part of the light bulb shaped lamp according to the embodiment 7 of the present invention. Note that, in FIG. 10, the fixing component 40 is illustrated in broken lines.

Since the overall basic configuration of the light bulb shaped lamp 1F according to the embodiment 7 of the present invention is identical to that of the light bulb shaped lamp 1 according to the embodiment 1 of the present invention. Thus, the description for the overall configuration of the lamp shall be omitted. In addition, the same reference numerals are assigned to the components identical to the components illustrated in FIGS. 1 to 4 in FIG. 10, and the detailed description for these components shall be omitted.

The light bulb shaped lamp 1F according to the embodiment 7 of the present invention is different from the light bulb shaped lamp 1 according to the embodiment 1 of the present invention in the configuration of the LED module.

As illustrated in FIG. 10, in the light bulb shaped lamp 1F according to the embodiment 7, one row of LEDs are mounted on the surface of each side of the board 21, and the sealing components 23F1 and 23F2 for sealing the LEDs are formed in the LED module 20F. The sealing components 23F1 and 23F2 may be composed of the same material as the sealing component 23 in the embodiment 1.

Furthermore, in the LED module 20F according to the embodiment 7, the first power supply terminal 27F and the second power supply terminal 28F are formed only on one side of the board 21 on the side of the fixing component 40, and the first power supply terminal 27F and the second power supply terminal 28F are formed on different surfaces of the board 21.

In addition, the lines 24 are patterned on both sides of the upper part of the board 21 such that the LEDs in the sealing component 23F1 formed on one surface and the LEDs in the sealing component 23F2 formed on the other surface are connected in series through a contact hole 29. As illustrated in FIG. 10, the sealing component 23F1 and the sealing component 23F2 are provided with the mounting positions shifted from each other through the board 21. However, the sealing component 23F1 and the sealing component 23F2 may be provided right behind each other such that the sealing components overlap via the board 21.

According to the light bulb shaped lamp 1F according to the embodiment 7 of the present invention, it is possible to achieve the effects equivalent to the effects of the embodiment 1.

Furthermore, with the configuration described above, in the light bulb shaped lamp 1F according to the embodiment 7, it is possible to increase the insulating distance between the first power supply terminal 27F and the second power supply terminal 28F at the creeping discharge part. Thus, it is possible to further prevent the discharge between the first power supply terminal 27F and the second power supply terminal 28F from occurring.

Note that, in the embodiment 7, the first light-emitting area and the second light-emitting area are formed as light-emitting regions including the LED and the phosphor-containing resin. Accordingly, as a board, it is not necessary to use a translucent board with high transmittance. In this case, it is not necessary to form the sintered-material film. In contrast, when the translucent board with high transmittance is used as in the other embodiments, it is preferable to form a sintered material film in the same manner as the embodiment 1 in areas opposite to the sealing component 23F1 and the sealing component 23F2 on both sides of the board. With this, among the light emitted by the LEDs mounted on both surfaces, the wavelength of the light transmitted the board is converted by the sintered-material film such that the entire LED module 20F can emit the same light. With this, in the embodiment 7, the configurations of the boards may be the same on both sides. Accordingly, it is possible to easily set the light emitted from the first light-emitting area and the light emitted from the second light-emitting area without deviation in color.

### Embodiment 8

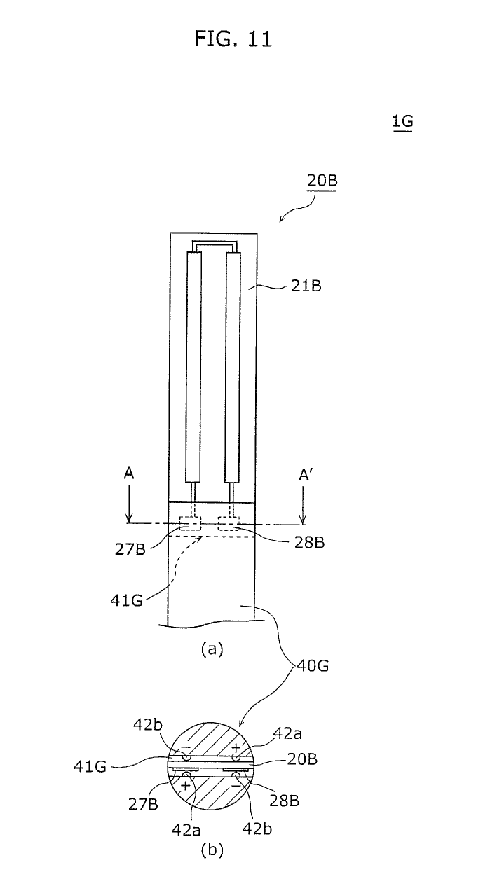

A light bulb shaped lamp 1G according to the embodiment 8 of the present invention shall be described with reference to FIG. 11. FIG. 11 is an enlarged view of the major part of the light bulb shaped lamp according to the embodiment 8 of the present invention. In FIG. 11, (a) is a plan view, and (b) is a cross-sectional view along A-A′ in (a) in FIG. 11.

Since the overall basic configuration of the light bulb shaped lamp 1G according to the embodiment 8 of the present invention is identical to that of the light bulb shaped lamp 1B according to the embodiment 3 of the present invention. Thus, the description for the overall configuration of the lamp shall be omitted. In addition, the same reference numerals are assigned to the components identical to the components illustrated in FIG. 6 in FIG. 11, and the detailed description for these components shall be omitted.

The light bulb shaped lamp 1G according to the embodiment 8 is different from the light bulb shaped lamp 1B according to the embodiment 3 of the present invention in the configuration of the fixing component.

As illustrated in (a) and (b) in FIG. 11, in the light bulb shaped lamp 1G according to the embodiment 8, the fixing component 40G includes a groove 41G for inserting the edge portion of the board 21B in the LED module 20B. On the inner side surfaces of the groove 41G, a first contacts 42a and a second contacts 42b are provided as contacts for supplying power to the first power supply terminal 27B and the second power supply terminal 28B in the LED module 20B. More specifically, the first contacts 42a and the second contacts 42b are provided instead of the first lead wire 71 and the second lead wire 72 in FIG. 6, and are electrically connected to the output terminals of the lighting circuit 80.

The first contacts 42a and the second contacts 42b are configured such that the board 21B contacts the first power supply terminal 27B and the second power supply terminal 28B when the board 21B is inserted into the groove 41G into a predetermined position in the fixing component 40G. With this, the LED module 20B is fixed with the fixing component 40G, and the LED module 20B and the lighting circuit 80 are electrically connected.

According to the light bulb shaped lamp 1G according to the embodiment 8 of the present invention, it is possible to achieve the effects equivalent to the effects of the embodiment 3.

Furthermore, according to the light bulb shaped lamp 1G according to the embodiment 8, it is possible to fix the LED module 20B and to establish electric connection at the same time. This facilitates assembly.

Note that, in the embodiment 8, the first contacts 42a and the second contacts 42b are provided for both of the side surfaces of the groove 41 opposite to each other. However, the first contact 42a and the second contact 42b may be formed on the side surfaces of only one side. Alternatively, by providing the first contact 42a and the second contact 42b on the side surfaces of the groove 41 opposite to each other, it is possible to connect the power supply terminal with the contact, regardless of which side the board 21B is facing. In other words, the board 21B may be inserted into the groove 41 without considering the orientation of the main surface the board 21B. This further facilitates assembly. Note that, in this case, the first contact 42a and the second contact 42b that are not connected to the power supply terminals abut the board 21B, and are used for supporting the board 21B.

### Embodiment 9

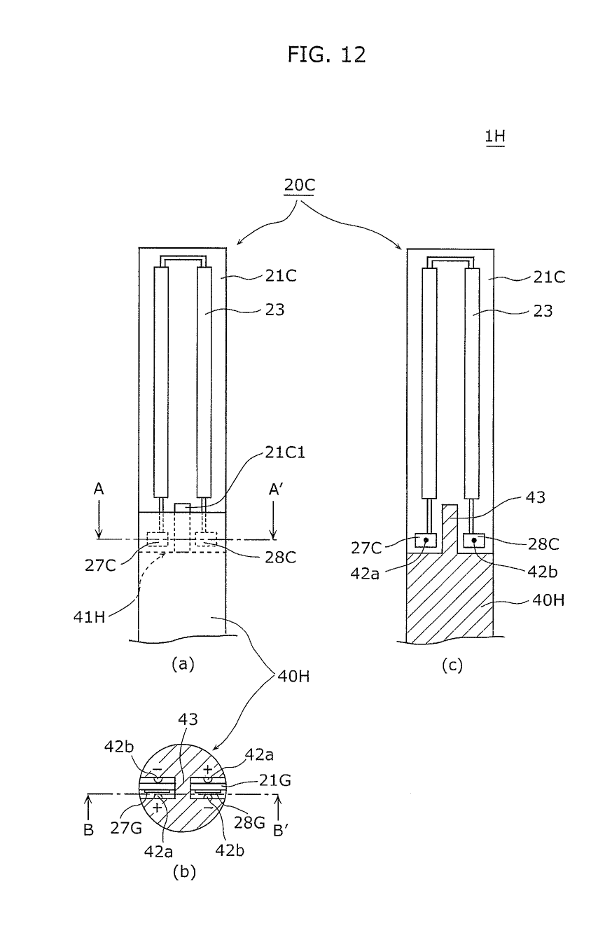

A light bulb shaped lamp 1H according to the embodiment 9 of the present invention shall be described with reference to FIG. 12. FIG. 12 is an enlarged view of the major part of the light bulb shaped lamp according to the embodiment 9 of the present invention. In FIG. 12, (a) is a plan view, (b) is a cross-sectional view along A-A′ in (a) in FIG. 12, and (c) is a cross-sectional view along B-B′ in (b) FIG. 12.

Since the overall basic configuration of the light bulb shaped lamp 1H according to the embodiment 9 of the present invention is identical to that of the light bulb shaped lamp 1C according to the embodiment 4 of the present invention. Thus, the description for the overall configuration of the lamp shall be omitted. In addition, the same reference numerals are assigned to the components identical to the components illustrated in FIG. 7 in FIG. 12, and the detailed description for these components shall be omitted.

The light bulb shaped lamp 1H according to the embodiment 9 is different from the light bulb shaped lamp 1C according to the embodiment 4 of the present invention in the configuration of the fixing component.

As illustrated in (a) to (c) in FIG. 12, in the light bulb shaped lamp 1H according to the embodiment 9, a plug-in part 43 is provided in the fixing component 40H for inserting the LED module 20C into a slit 21C1 in the board 21C. More specifically, the fixing component 40H includes two grooves 41H at which two projections configured by forming the slit 21C1 in the board 21C. The first contact 42a and the second contact 42b are provided on the inner side surfaces of the groove 41H in the same manner as the embodiment 8, as electric contacts for supplying power to the first power supply terminal 27C and the second power supply terminal 28C in the LED module 20C. More specifically, the first contact 42a and the second contact 42b are provided instead of the first lead wire 71 and the second lead wire 72 in FIG. 7, and are electrically connected to the output terminals of the lighting circuit 80.

The first contact 42a and the second contact 42b are configured to contact the first power supply terminal 27C and the second power supply terminal 28C when the slit 21C1 in the board 21C is inserted into the plug-in part 43 (that is, the two projections of the board 21C are inserted into the groove 41H) such that the board 21C is positioned at a predetermined position of the fixing component 40H. With this, at the same time as fixing the LED module 20C in the fixing component 40H, the LED module 20C and the lighting circuit 80 can be electrically connected.

According to the light bulb shaped lamp 1H according to the embodiment 9 of the present invention, it is possible to achieve the effects equivalent to the effects of the embodiment 4.

Furthermore, according to the light bulb shaped lamp 1H according to the embodiment 9, it is possible to fix the LED module 20C and to establish electric connection at the same time, in the same manner as the embodiment 8. This facilitates assembly.

Note that, the first contacts 42a and the second contacts 42b in the embodiment 9 are provided on both side surfaces of the groove 41H opposite to each other. However, in the same manner as the embodiment 8, the first contact 42a and the second contact 42b may be formed only on one side of the side surfaces.

### Embodiment 10

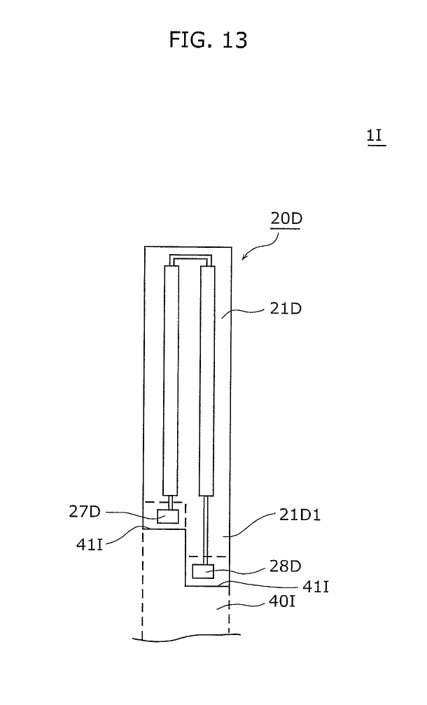

A light bulb shaped lamp 1I according to the embodiment 10 of the present invention shall be described with reference to FIG. 13. FIG. 13 is an enlarged plan view of the major part of the light bulb shaped lamp according to the embodiment 10 of the present invention. Note that, in FIG. 13, the fixing component 40I is illustrated in broken lines.

Since the overall basic configuration of the light bulb shaped lamp 1I according to the embodiment 10 of the present invention is identical to that of the light bulb shaped lamp 1D according to the embodiment 5 of the present invention. Thus, the description for the overall configuration of the lamp shall be omitted. In addition, the same reference numerals are assigned to the components identical to the components illustrated in FIG. 8 in FIG. 13, and the detailed description for these components shall be omitted.

The light bulb shaped lamp 1I according to the embodiment 10 is different from the light bulb shaped lamp 1D according to the embodiment 5 of the present invention in the configuration of the fixing component.

In the light bulb shaped lamp 1I according to the embodiment 10, the groove 41I for inserting the peripheral portion of the fixing component 40I is formed. On the inner side surface of the groove 41I, the first contacts 42a (not illustrated) and the second contacts 42b (not illustrated) are provided as the electric contacts for supplying power to the first power supply terminal 27D and the second power supply terminal 28D in the LED module 20D in the same manner as the embodiment 8 and the embodiment 9.

In the same manner as the embodiment 8 and the embodiment 9, the first contacts 42a and the second contacts 42b are configured to contact the first power supply terminal 27D and the second power supply terminal 28D, when the board 21D is inserted into the groove 41 and the board 21D and is positioned at a predetermined position of the fixing component 40I. With this, the LED module 20D and the lighting circuit 80 are electrically connected, at the same time as fixing the LED module 20D to the fixing component 40I.

According to the light bulb shaped lamp 1I according to the embodiment 10 of the present invention, it is possible to achieve the effects equivalent to the effects of the embodiment 5.

Furthermore, according to the light bulb shaped lamp 1I according to the embodiment 10, the LED module 20D can be fixed while establishing electric connection at the same time, thereby facilitating assembly.

### Embodiment 11

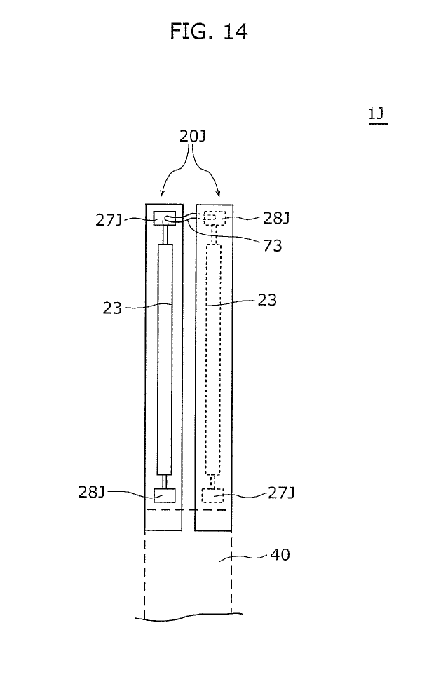

A light bulb shaped lamp 1J according to the embodiment 11 of the present invention shall be described with reference to FIG. 14. FIG. 14 is an enlarged plan view of the major part of the light bulb shaped lamp according to the embodiment 11 of the present invention. Note that, in FIG. 14, the fixing component 40 is illustrated in broken lines.

Since the overall basic configuration of the light bulb shaped lamp 1J according to the embodiment 11 of the present invention is identical to that of the light bulb shaped lamp 1 according to the embodiment 1 of the present invention. Thus, the description for the overall configuration of the lamp shall be omitted. In addition, the same reference numerals are assigned to the components identical to the components illustrated in FIGS. 1 to 4 in FIG. 14, and the detailed description for these components shall be omitted.

The light bulb shaped lamp 1J according to the embodiment 11 of the present invention is different from the light bulb shaped lamp 1 according to the embodiment 1 of the present invention in that a plurality of LED modules 20J are fixed with the fixing component 40.

AS illustrated in FIG. 14, in the light bulb shaped lamp 1J according to the embodiment 11, two LED modules 20J are used. In each of the LED modules 20J, the width of the board 21J is approximately half the width of the board 21 according to the embodiment 1. One row of LEDs are arranged only on one side of the board 21J, and one line of sealing component 23 is formed to cover the LEDs. Note that, the first power supply terminal 27J and the second power supply terminal 28J are formed on one end and the other end of the board 21J on the shorter side. In addition, although not illustrated, the sintered material film is formed on a side opposite to a side on which the LEDs are mounted.

In the light bulb shaped lamp 1J according to the embodiment 11, the two LED modules 20 are fixed with the fixing component 40 such that the first main surface of one of the two LED modules 20J (a surface on which the sealing component 23 is formed) is opposite to the first main surface of the other LED module 20J (a surface on which the sealing component 23 is formed).

Note that, the two LED modules 20J are arranged such that the side surfaces on the longer sides face each other and such that the first main surface of one of the LED modules 20J and the second main surface of the other of the LED modules 20J are formed in the substantially same plane.

The method of fixing the LED modules 20J to the fixing component 40 may be the same as in the embodiment 1. However, the positions of the power supply terminals are upside down in one of the LED modules 20J and the other of the LED modules 20J. For example, as illustrated in FIG. 14, one of the LED modules 20J are arranged such that the first power supply terminal 27J is arranged on the fixing component 40 side and the other of the LED modules 20J is arranged such that the second power supply terminal 28J is arranged on the fixing component 40 side.

With this, on the upper part of the board 21J, the second power supply terminal 28J and the second power supply terminal 27J are arranged at the same height at the upper part of the board 21J, and thereby facilitating the electric connection between the second power supply terminal 28J and the first power supply terminal 27J by the lead wire 73.

As described above, according to the light bulb shaped lamp 1J according to the embodiment 11 of the present invention, the two LED modules 20J are arranged opposite to each other. Thus, it is possible to emit the same light toward the side circumferential portion of the globe 10.

The light bulb shaped lamp according to the present invention has been described based on the embodiments. However, the present invention is not limited to the embodiments.

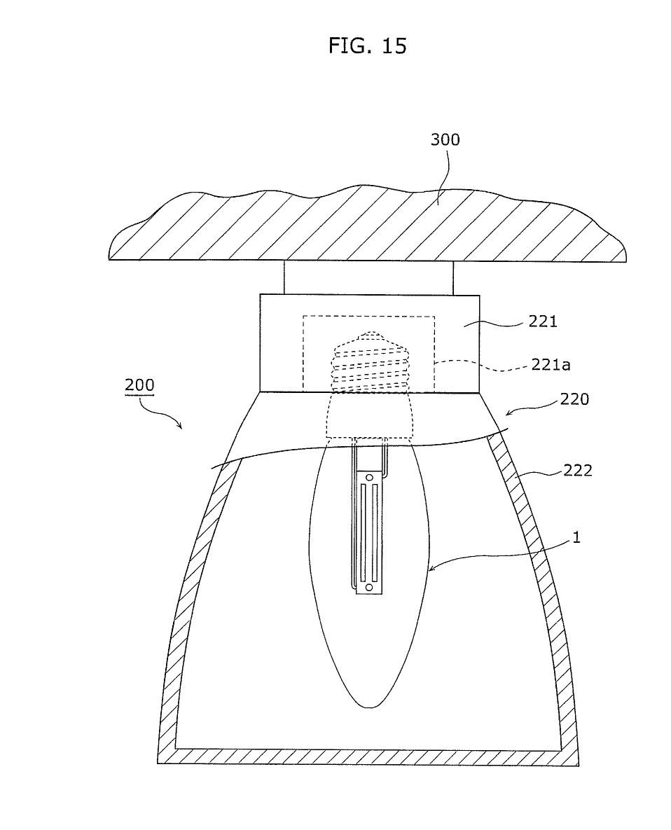

For example, the present invention may not only be implemented as the light bulb shaped lamp, but also as a lighting apparatus including the light bulb shaped lamp. The following shall describe the lighting apparatus 200 according to an aspect of the present invention with reference to FIG. 15. FIG. 15 is a schematic cross-sectional view of the lighting apparatus according to the embodiment of the present invention.

As illustrated in FIG. 15, the lighting apparatus 200 according to the embodiment is used attached to a ceiling 300 in a room, and includes the light bulb shaped lamp 1 according to the embodiment 1 of the present invention and a lighting equipment 220.

The lighting equipment 220 is for turning the light bulb shaped lamp 1 on and off, and includes an equipment body 221 attached to the ceiling 300 and a lamp cover 122 covering the light bulb shaped lamp 1.

The equipment body 221 includes a socket 221a. The base 30 of the light bulb shaped lamp is screwed into the socket 221a. Power is supplied to the light bulb shaped lamp 1 through the socket 221a.

Note that the lighting apparatus 200 illustrated in FIG. 15 includes one light bulb shaped lamp 1. However, the lighting apparatus 200 may include more than one light bulb shaped lamp 1. As the light bulb shaped attached to the lighting apparatus 200, in addition to the light bulb shaped lamp 1 according to the embodiment 1, the light bulb shaped lamps according to the other embodiments may also be used.

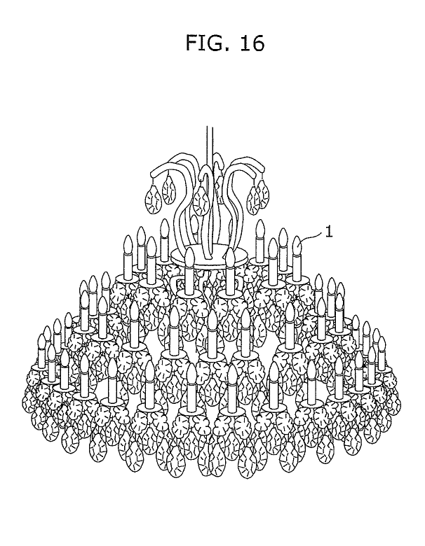

The lighting apparatus to which the light bulb shaped lamp according to the present invention is applied is not limited to the lighting apparatus 200 illustrated in FIG. 15. For example, the light bulb shaped lamp 1 and others according to the present invention may be applied to a chandelier-type lighting apparatus as illustrated in FIG. 16.

Note that, the lighting apparatuses illustrated in FIGS. 15 and 16 are only examples, and the lighting apparatus according to the present invention requires at least a socket for holding the light bulb shaped lamp and for supplying power to the light bulb shaped lamp.

Furthermore, in the embodiments, the supporting component 50 is housed in the resin case 60. However, it is not limited to this example. For example, a part of the supporting component 50 may be exposed to the outer air. More specifically, in FIG. 3, the thickness of the second supporting part 52 of the supporting component 50 may be increased such that the side surface of the second supporting portion 52 is exposed to outside.

As described above, by exposing part of the supporting component 50, the heat from the LED module 20 conducted from the fixing component 40 to the supporting component 50 may be directly dissipated to outer air (in the air) from the exposed part of the supporting component 50. Thus, it is possible to increase the heat-dissipating property. Furthermore, in this case, it is preferable that the Alumite treatment is performed on the exposed part of the supporting component made of aluminium.

Furthermore, in the embodiment described above, the LED module is provided standing on the fixing component such that a tilt angle (an angle between the main surface of the board of the LED module and the upper surface of the fixing component) is substantially 90 degrees. However, it is not limited to this configuration. For example, the LED module is provided standing on the fixing component with a tilt angle over 0 degree, especially between 20 degrees and 90 degrees. Note that, for example, a light bulb shaped lamp having approximately 55 degrees to 65 degrees of the tilt angle is preferable since the light bulb shaped lamp may be widely used for a lighting equipment having a socket with an opening for inserting the base at the side circumferential part of the lamp cover. In this case, the light bulb shaped lamp is attached to the lighting equipment tilted with respect to the horizontal plane. However, the board of the LED module may be configured substantially in parallel with the horizontal plane. Note that, in this case, it is preferable to provide a rotational mechanism between the base and the case.

In the embodiments above, the LED module is configured to emit the light obtained by the wavelength conversion on the light emitted from the LED as the predetermined light. However, it is not limited to this example. For example, the LED module may be configured such that the light emitted from the LED may be emitted as the predetermined light. In this case, phosphor particles are not included in the sealing component for sealing the LED, and the sintered material film is not formed.

Furthermore, in the embodiments described above, the LED is used as an example of the semiconductor light-emitting device. However, the semiconductor light-emitting device may be a semiconductor laser and an organic electro luminescent (EL) light-emitting device.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable to a light bulb shaped lamp replacing conventional incandescent light bulbs, particularly as a light bulb shaped lamp and a lighting apparatus including the light bulb shaped LED lamp.

### REFERENCE SIGNS LIST

1, 1A, 1B, 1C, 1D, 1E, 1F, 1G, 1H, 1I, 1J Light bulb shaped lamp
10 Globe
11 Opening
11a Opening end
20, 20A, 20B, 20C, 20D, 20E, 20F, 20J, 440 LED module
21, 21A, 21B, 21C, 21D, 21E, 21J Board
21a First main surface
21b Second main surface
21C1 Slit
21D1 Extended portion
21E1 First wide part
21E2 Second wide part
22 LED
23, 23F1, 23F2 Sealing component
24 Line
25 Wire
26 Sintered-material film
27, 27B, 27C, 27D, 27E, 27F, 27J First power supply terminal
28, 28B, 28C, 28D, 28E, 28F, 28J Second power supply terminal
27h, 28h Through holes
29 Contact hole
30, 420 Base
40, 40D, 40G, 40H, 40I Fixing component
41, 41D, 41G, 41H, 41I Groove
42a First contact
42b Second contact
43 Plug-in part
50 Supporting component
51 First supporting part
52 Second supporting part
53 Gap
60 Resin case
61 First case part
62 Second case part
71 First lead wire
72, 72A Second lead wire
73 Lead wire
80, 460 Lighting circuit
91 Adhesive material
92 Solder
200 Lighting apparatus
220 Lighting equipment
221 Equipment body
221a Socket
222 Lamp cover
300 Ceiling
400 Light bulb shaped LED lamp
410 Cover
430 Outer case
431 Circumferential portion
432 Light source attachment
433 Recess
450 Insulating component
LA1 First light-emitting area
LA2 Second light-emitting area

1-19. (canceled)

20. An light bulb shaped lamp comprising:
a globe which is hollow;
a light-emitting module housed in said globe; and
a fixing component for fixing said light-emitting module,
wherein said light-emitting module includes:
a translucent board having a first main surface and a second main surface opposite to the first main surface;
a semiconductor light-emitting device mounted on the first main surface of said board;
a first wavelength conversion part which is formed on the first main surface of said board and performs wavelength conversion on light emitted by said semiconductor light-emitting device into predetermined light; and
a second wavelength conversion part which is formed on the second main surface of said board and performs wavelength conversion on light emitted by said semiconductor light-emitting device into predetermined light, and
said board is provided standing on said fixing component.

21. The light bulb shaped lamp according to claim 20,
wherein said globe has an opening plane, and
the first main surface of said board is substantially orthogonal to the opening plane.

22. The light bulb shaped lamp according to claim 20,
wherein an edge portion of said board is fixed to said fixing component.

23. The light bulb shaped lamp according to claim 22,
wherein said light-emitting module further includes: a first power supply terminal and a second power supply terminal for supplying voltage from an external power source to said semiconductor light-emitting device,
said first power supply terminal is formed on an end portion of said board on a side of said fixing component, and
said second power supply terminal is formed on an end portion of said board on a side opposite to the side of said fixing component.

24. The light bulb shaped lamp according to claim 23, further comprising
at least two light-emitting modules each of which is said light-emitting module,
wherein said two light-emitting modules are fixed to said fixing component such that the first main surface of one of said two light-emitting modules is in a direction opposite to the first main surface of the other of said two light-emitting modules.

25. The light bulb shaped lamp according to claim 22,
wherein said light-emitting module further includes a first power supply terminal and a second power supply terminal for supplying voltage to said semiconductor light-emitting device, and
said first power supply terminal and said second power supply terminal are formed on an end portion of said board on a side of said fixing component.

26. The light bulb shaped lamp according to claim 25,
wherein said first power supply terminal is formed on the first main surface of said board, and
said second power supply terminal is formed on the second main surface of said board.

27. The light bulb shaped lamp according to claim 25,
wherein said fixing component has a groove, and
the edge portion of said board is inserted into the groove.

28. The light bulb shaped lamp according to claim 27,
wherein said fixing component includes an electric contact for supplying power to said first power supply terminal and said second power supply terminal, and
the contact is formed on the groove.

29. The light bulb shaped lamp according to claim 25,
wherein said board includes, on a side of said fixing component, a wide part at which a width is greater than other parts, and
said first power supply terminal and said second power supply terminal are formed on the wide-width part.

30. The light bulb shaped lamp according to one of claims 25,
wherein said board has a slit formed between said first power supply terminal and said second power supply terminal.

31. The light bulb shaped lamp according to claim 30,
wherein said fixing component includes a plug-in part to be inserted into said slit.

32. The light bulb shaped lamp according to claim 31,
wherein said fixing component has an electric contact for supplying power to said first power supply terminal and said second power supply terminal, and
the electric contact is formed at the plug-in part.

33. The light bulb shaped lamp according to claim 20,
wherein said fixing component is composed of a material having a thermal conductivity higher than a thermal conductivity of said board.

34. The light bulb shaped lamp according to claim 20,
wherein a transmission factor of said board is 80% or higher.

35. The light bulb shaped lamp according to claim 20, comprising:
a base for receiving power causing said semiconductor light-emitting device to emit light; and
a case for insulating at least said fixing component and said base, and housing a lighting circuit for turning on said semiconductor light-emitting device.

36. A lighting apparatus comprising
the light bulb shaped lamp according to claim 20.

37. The light bulb shaped lamp according to claim 20,
wherein said second wavelength conversion part is a sintered material film formed on the second main surface, and
the sintered material film is composed of a wavelength conversion material which converts a wavelength of the light emitted by said semiconductor light-emitting device transmitted said board, and a binder for sintering made of an inorganic material.
